(19) United States
(12) Patent Application Publication
(10) Pub. No.: US 2010/0077167 A1
(43) Pub. Date: Mar. 25, 2010

(54) DATA STORAGE DEVICE HAVING SMART CARD BASED COPY PROTECTION FUNCTION, AND METHOD FOR STORING AND TRANSMITTING DATA THEREOF

(76) Inventors: Byeong Cheol Choi, Daejeon (KR); Seung Wan Han, Gwangju (KR); Byung Ho Chung, Daejeon (KR); Jeong Nyeo Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/517,102

(22) PCT Filed: Oct. 9, 2007
(86) PCT No.: PCT/KR2007/004908

§ 371 Date: Jun. 1, 2009

(30) Foreign Application Priority Data
Dec. 6, 2006 (KR) 10-2006-0123116

(51) Int. Cl. G06F 12/14; G06K 19/00; G06F 12/00

(52) U.S. Cl. 711/164; 235/492; 711/E12.001; 711/E12.094

(57) ABSTRACT

A data storage device having a smart card based copy protection function is provided. The data storage device encodes data using the temper resistant key of the smart card as the encoding seed, stores the encoded data, and transmits the encoded data to other device. Therefore, it is impossible to modulate or to make the illegal copy of stored or transmitted data, and the reliability of the storage device can be improved.

### TECHNICAL FIELD

The present invention relates to a data storage device, and, more particularly, to a data storage device having a smart card based copy protection function for encoding the data and digital contents based on smart card information when a data and digital contents are stored and the stored data and digital contents are outputted, and a method thereof.

This work was supported by the IT R&D program of MIC/IITA. [2005-S-402-02, Project title: The development of the high performance network security system]

### BACKGROUND ART

As communication technology has been advanced, contents are generally distributed through diverse service channels such as an Internet, a wireless broadband (Wibro), digital multimedia broadcasting (DMB), a public wireless LAN service (WLAN), and a wireless personal area network (WPAN). In order to store such data and contents, a mass storage device has been used.

Recently, a secure digital card (SD card), a multimedia card (MMC), and a universal serial bus memory (USB memory) were popularly used as a storage device for transmitting and storing data.

Since these storage devices do not guarantee the reliability of a key used for copy protection in encoding, storing, and transmitting data, the reliability and the stability thereof for copy protection are degraded.

### DISCLOSURE OF INVENTION

### Technical Problem

An aspect of the present invention is to provide a data storage device having a smart card based copy protection function for preventing data from being copied and guaranteeing the reliability thereof in storing data and transmitting the stored data by performing a copy protection process using a tamper resistant key of a smart card, and a control method thereof.

### Technical Solution

According to an aspect of the invention, the present invention provides a data storage device includes an interface, a control unit, a smart card, an encoding chip and a memory. The interface transmits and receives data requested to read or write. The control unit controls transmission and reception of the data through the interface. The smart card provides tamper resistant key information used to encode and decode the data transmitted and received through the interface. The encoding chip encodes or decodes the data transmitted and received through the interface using the tamper resistant key. The memory stores the encoded data.

According to another aspect of the invention, the invention provides a data storage device having a smart card based copy protection function includes an interface, a control unit, a smart card, and a memory. The interface transmits and receives data requested to read or write. The control unit controls transmission and reception of the data through the interface, and the smart card encodes or decodes the data transmitted and received through the interface using an internal tamper resistant key, and the memory stores the encoded data.

According to further another aspect of the invention, the invention provides a method of storing data in a data storage device including: receiving data to be stored; acquiring a tamper resistant key of a smart card; encoding the received data based on the acquired tamper resistant key; and storing the encoded data.

The receiving the storing data may include: receiving the tamper resistant key of the smart card of other storage device from the other storage device before the acquiring the tamper resistant key if the received data is encoded data of the other storage device having a smart card based copy protection function; and decoding the received data using the tamper resistant key received from the other storage device.

According to yet another aspect of the invention, the invention provides a method of storing data in a data storage device including: acquiring a tamper resistant key of an own smart card when it is requested to transmit data to other storage device; reading and decoding the requested data based on the acquired tamper resistant key; receiving the tamper resistant key of a smart card in a storage device to transmit the data; encoding the decoded data based on the transmitted tamper resistant key; and transmitting the encoded data to the other storage device.

### Advantageous Effects

A storage device having a smart card based copy protection function according to the certain embodiment of the present invention encodes data using the temper resistant key of the smart card as the encoding seed, stores the encoded data, and transmits the encoded data to other device. Therefore, it is impossible to modulate or to make the illegal copy of stored or transmitted data, and the reliability of the storage device can be improved.

### BRIEF DESCRIPTION OF THE DRAWINGS

The above objects, other features and advantages of the present invention will become more apparent by describing the preferred embodiments thereof with reference to the accompanying drawings, in which:

FIG. 1 and FIG. 2 are block diagrams illustrating a data storage device having a smart card based copy protection function according to an exemplary embodiment of the present invention;

FIG. 2 is a block diagram illustrating a smart card used in an exemplary embodiment of the present invention;

FIG. 4 is a flowchart illustrating a method for storing data in data storage device having a smart card based copy protection function according to an exemplary embodiment of the present invention;

FIG. 5 is a flowchart illustrating a method for transmitting data between data storage devices having a smart card based copy protection function according to another embodiment of the present invention; and

FIG. 6 is a flowchart illustrating a method for transmitting data between data storage devices having a smart card based copy protection function according to still another exemplary embodiment of the present invention.

### BEST MODE FOR CARRYING OUT THE INVENTION

Exemplary embodiments of the present invention will now be described in detail with reference to the accompanying drawings. Like reference numerals denote like elements throughout accompanying drawings. Also, the detail description of well-known functions and configuration may be omitted in order to clearly describe the present invention.

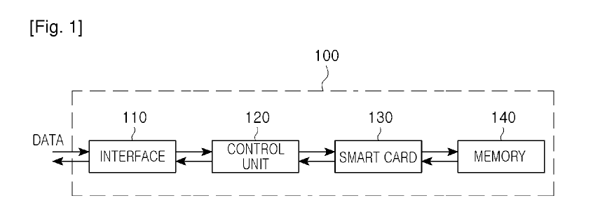

FIG. 1 is a block diagram illustrating a data storage device having a smart card based copy protection function according to an exemplary embodiment of the present invention.

Referring to a diagram of FIG. 1, the data storage device having a smart card based copy protection function according to the present embodiment includes an interface 110, a control unit 120, a smart card 130, and a memory 140. The interface 110 receives data requested to write or outputs data requested to read. The control unit 120 controls input/output of the data through the interface 110. The smart card 130 includes a tamper resistant key used to encode and decode data and encodes/decodes data transmitted through the control unit 120 based on the tamper resistant key. The memory 140 stores the data encoded in the smart card 130.

The interface 110 may include at least one of a universal serial bus (USB) interface, an IEEE 1394 interface, and a wireless personal area network (WPAN) interface. It is preferable to have all interfaces selectable according to a corresponding storage device. When multiple interfaces are included, the control unit 120 selects one of the multiple interfaces to input and output the data.

The storage device 100 is connected to a host such as other storage device or a mobile device through the interface 110 to receive data to store, to read data, and to transmit the read data. For example, the host may be a mass capacity memory, a data storage device having a smart card based copy protection function according to the present embodiment, or a mobile device supporting digital right management (DRM), conditional access system (CAS), and communication processor.

The control unit 120 controls a data flow such as data output from the storage device 100 or data input to the storage device 100. For example, the control unit 120 may include a communication processor and a communication memory.

The smart card 130 includes a memory and a central processing unit (CPU). That is, the smart card 130 can have a function of authenticating an object to access and a function of managing memory data through the CPU. The smart card 130 includes a tamper resistant key or identification (ID), which are referred to the tamper resistant key hereinafter. The tamper resistant key embedded into the smart card 130 is used as an encoding seed in an internal encoding engine. It is preferable to realize a smart card 130 to be attachable so as to enable the smart card to be exchanged, thereby improving the security and the efficiency of the storage device 100. The smart card 130 can be embodied as a chip type.

The smart card 130 encodes and decodes input and output data using the tamper resistant key of the smart card 130 as an encoding seed through the internal encoding engine. It is preferable to realize the encoding engine for encoding and decoding data as a high speed crypto-chip (HSCC) capable of encoding and decoding data at high-speed. For example, the encoding process is performed according to transmission related copy protection rule of digital transmission content protection (DTCP), which is one of technologies for copy protection of digital data. According to the DTCP standard, illegal copy is prevented by transmitting and receiving contents with an attribute of prohibiting making a copy of contents or an attribute of permitting to make one time copy for a long time. Accordingly, data transmission is allowed to devices employing the DTCP.

As another example of the encoding standard, a record-related copy protection standard such as copy protection for recordable media (CPRM) can be used. The CPRM is a hardware-based technology designed to insert copy protection constraint conditions in a recordable media structure in order to prevent file from copying without permission. When the storage device 100 adopts the CPRM standard for copy protection, the storage device 100 may be a recording media such as a digital video disk (DVD) and a flash memory card.

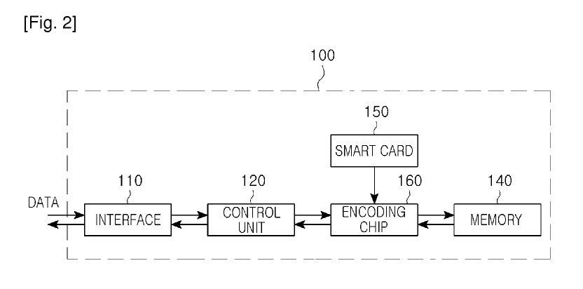

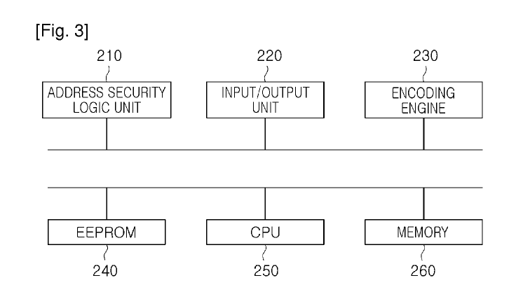

Referring to a diagram of FIG. 2, the storage device according to the present embodiment may further includes an encoding chip 160 separated from a smart card 150 to encode data. In this case, the smart card 150 included in the storage device 100 of FIG. 2 does not need to have an encoding engine and can provide the tamper resistant key upon request. The encoding chip 160 encodes data to be stored based on the tamper resistant key provided from the smart card 150, transmits the data to the memory 140, and decodes read data transmitted from the memory 140. It is also preferable to realize the smart card 150 to be attachable.

The storage device 100 formed as described above can be realized as a mobile card, which can be connected to a portable telephone or a portable terminal. If the capacity of the memory 140 is large, the storage device 100 can be realized as a large-capacity storage device.

FIG. 2 is a block diagram illustrating a smart card used in an exemplary embodiment of the present invention. Referring to FIG. 2, the smart card generally includes an address security logic unit 210, an input/output unit 220, an encoding engine 230, an electrically erasable and programmable read only memory (EEPROM) 240, a CPU 250 and a memory 260.

The address security logic unit 210 secures a key value or a transmission address when the tamper resistant key of the smart card is transmitted in an encoding process or a decoding process. In another embodiment of the present invention, the key value can be secure by encoding the key value with a predetermined encoding scheme which is selected by both of the storing devices when data are exchanged between two storage devices having a smart card based copy protection function according to the present embodiment.

In a diagram of FIG. 2, the input/output unit 220 transmits the tamper resistant key of the smart card, which is required for an encoding process and a decoding process, to the encoding chip 160. In a diagram of FIG. 1, the input/output unit 220 inputs data to encode or to decode and outputs encoded data or decoded data. In the diagram of FIG. 1, the encoding engine 230 encodes or decodes inputted/outputted data using the tamper resistant key of the smart card.

The EEPROM 240 has tamper resistant key information and can modify the tamper resistant key value according to needs. For example, when the storage device according to the present embodiment is required to be used as new purpose, the smart card is detached from the storage device, a previous tamper resistant value is removed from the smart card, and a new temper resistant value is inserted to the smart card. Then, the smart card can be attached to the storage device in order to use the storage device for another purpose. Or, the smart card with new tamper resistant key information can be attached to a new storage device having a smart card based copy protection function.

The CPU 250 and the memory 260 are used to encode and decode the data to be transmitted or received.

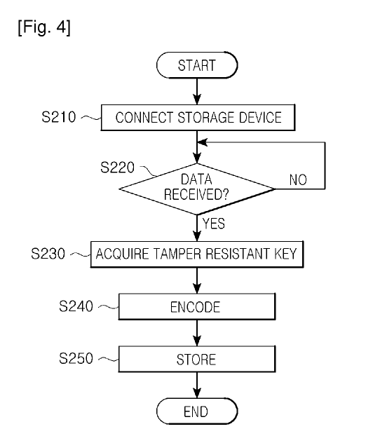

FIG. 4 is a flowchart illustrating a method for storing data in data storage device having a smart card based copy protection function according to an exemplary embodiment of the present invention. Referring to FIG. 4, data is stored in the storage device according to the present embodiment or the storage device is connected to the other device to use the stored data at S210. The other device may be any device capable of transmitting data, such as a general large capacity memory, a portable terminal, or a mobile terminal.

If the storage device receives data from the other device with the storage device connected to the other device at S220, the storage device acquires the information on the tamper resistant key from the smart card at S230. The storage device encodes the received data using the tamper resistant key as the encoding seed through the encoding engine embedded in the smart card or the encoding chip 160 at S240. The encoding process is performed according to the transmission related copy protection rule of DTCP or the storage related copy protection rule of CPRM. The encoded data is stored in the memory at S250. Since the data stored in the storage device is encoded through reliable temper resistant key as described above, illegal copy and usage can be prevented.

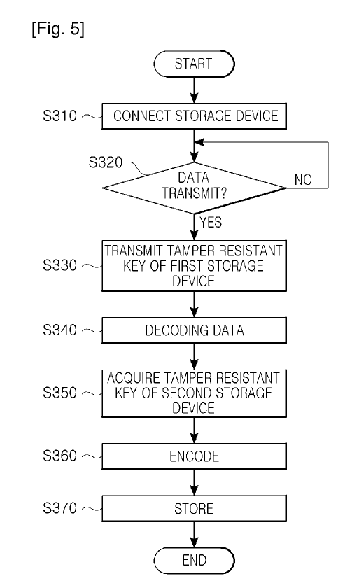

FIG. 5 is a flowchart illustrating a method for transmitting data between data storage devices having a smart card based copy protection function according to another embodiment of the present invention. Hereinafter, a first storage device denotes a side of transmitting data, and a second storage device denotes a side of receiving and storing data. The first storage device stores data encoded based on the tamper resistant key through the encoding processes shown in FIG. 4. When the data are stored in other storage device, an additional process is required.

Referring to FIG. 5, if the first storage device is connected to the second storage device for exchanging data and data is requested to transmit to the first storage device at S320, the first storage device transmits the tamper resistant key of its own smart card to the second storage device with the data at S330. The encoding chip of the second storage device decode the transmitted data using the tamper resistant key of the smart card of the first storage device at S340. Herein, the data transmitted from the first storage device to the second storage device is sustained as encoded. If the transmitted data are encoded by transmission based copy protection rule of DTCP, the data is decoded in consideration of the copy protection rule of DTCP at S340.

Then, the encoding chip of the second storage device acquires the tamper resistant key of its own smart card at S350 and encodes the decoded data again using the acquired key as an encoding seed at S360. The encoded data are stored in a memory of the second storage device at S370.

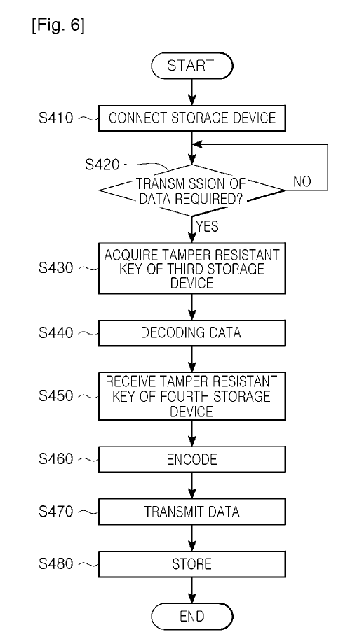

FIG. 6 is a flowchart illustrating a method for transmitting data between data storage devices having a smart card based copy protection function according to still another exemplary embodiment of the present invention.

A third storage device denotes a side of transmitting data, and a fourth storage device denotes a side of receiving and storing data, hereinafter. As described above, the data stored in the third storage device according to the present embodiment are data encoded using the tamper resistant key of the smart card included in the third storage device as an encoding seed.

If the third storage device is connected to the fourth storage device at S410 and it is requested to transmit data from the third storage device to the fourth storage device at S420, the third storage device acquires tamper resistant key information of its own smart card at S430 and decodes data to be transmitted based on the acquired tamper resistant key at S440. The third storage device receives the tamper resistant key from the smart card of the fourth storage device at S450, encodes the data decoded based on the tamper resistant key of the fourth storage device at S460, and transmits the data encoded based on the tamper resistant key of the fourth storage device to the fourth storage device at S470. The fourth storage device directly stores the encoded data transmitted from the third storage device in the memory without additionally processing the encoded data at S480.

The storage devices according to the present embodiment can direct transmit data to one anther. In order to directly transmit the data, the storage device according to the present embodiment may include an input unit for selecting object to transmit and inputting instructions, and an interface for connecting each storage device.

As an another example, the storage devices according to the present embodiment can indirectly transmit a data to other storage devices through a host such as a personal computer (PC), and the data transmission can be achieved through the relaying of the host.

While the present invention has been shown and described in connection with the preferred embodiments, it will be apparent to those skilled in the art that modifications and variations can be made without departing from the spirit and scope of the invention as defined by the appended claims.

1. A data storage device having a smart card based copy protection function comprising:
an interface for transmitting and receiving data requested to read or write;
a control unit for controlling transmission and reception of the data through the interface;
a smart card for providing tamper resistant key information used to encode and decode the data transmitted and received through the interface;
an encoding chip for encoding or decoding the data transmitted and received through the interface using the tamper resistant key; and
a memory for storing the encoded data.

2. The data storage device according to claim 1, wherein the smart card is attachable.

3. The data storage device according to claim 1, wherein the encoding chip encodes or decodes data according to a transmission related to copy protection standard of DTCP (digital transmission content protection).

4. The data storage device according to claim 1, wherein the encoding chip encodes or decodes data according to a storing related to copy protection standard of CPRM (content protection for recordable media).

5. The data storage device according to claim 1, wherein the interface includes at least one of a USB (universal serial bus) interface, an IEEE 1394 interface, and a WPAN (wireless personal area network) interface.

6. A data storage device having a smart card based copy protection function comprising:
an interface for transmitting and receiving data requested to read or write;
a control unit for controlling transmission and reception of the data through the interface;
a smart card for encoding or decoding the data transmitted and received through the interface using an internal tamper resistant key; and
a memory for storing the encoded data.

7. The data storage device according to claim 6, wherein the smart card is attachable.

8. The data storage device according to claim 6, wherein the smart card encodes or decodes data according to a transmission related copy protection standard of the DTCP.

9. The data storage device according to claim 6, wherein the smart card encodes or decodes data according to a storing related to copy protection standard of CPRM.

10. The data storage device according to claim 6, wherein the interface includes at least one of a USB (universal serial bus) interface, an IEEE 1394 interface, and a WPAN (wireless personal area network) interface.

11. A method of storing data in a data storage device comprising:
receiving data to be stored;
acquiring a tamper resistant key of a smart card;
encoding the received data based on the acquired tamper resistant key; and
storing the encoded data.

12. The method according to claim 11, wherein the receiving the storing data includes:
receiving the tamper resistant key of the smart card of other storage device from the other storage device before the acquiring the tamper resistant key if the received data is encoded data of the other storage device having a smart card based copy protection function; and
decoding the received data using the tamper resistant key received from the other storage device.

13. A method of storing data in a data storage device comprising:
acquiring a tamper resistant key of an own smart card when it is requested to transmit data to other storage device;
reading and decoding the requested data based on the acquired tamper resistant key;
receiving the tamper resistant key of a smart card in a storage device to transmit the data;
encoding the decoded data based on the transmitted tamper resistant key; and
transmitting the encoded data to the other storage device.
